(19) United States
(12) Patent Application Publication
(10) Pub. No.: US 2026/0292275 A1
(43) Pub. Date: Sep. 24, 2026

(54) METHOD, APPARATUS, DEVICE, MEDIUM AND PRODUCT FOR PROCESSING VIDEO STREAM

(71) Applicant: Beijing Zitiao Network Technology Co., Ltd., Beijing (CN)

(72) Inventors: Chaoyang GUO, Beijing (CN); Zhixin WU, Beijing (CN); Wenxuan ZHANG, Beijing (CN)

(21) Appl. No.: 19/571,211

(22) Filed: Mar. 18, 2026

(30) Foreign Application Priority Data
Mar. 18, 2025 (CN) 202510320530.2

(51) Int. Cl. H04N 21/2343; H04N 21/2187

(52) U.S. Cl. CPC H04N 21/2343; H04N 21/2187

(57) ABSTRACT

Embodiments of the present disclosure relate to a method, an apparatus, a device, a medium, and a program product for processing a video stream. The method includes determining, at a client, a video stream for live streaming. The method further includes determining, based on a performance of the client, whether to adjust an attribute of a target video frame in the video stream. The method further includes adjusting a color value of a target pixel in the target video frame in response to determining to adjust the attribute of the target video frame. The method further includes displaying the target video frame in the video stream having the adjusted target pixel.

### CROSS-REFERENCE TO RELATED APPLICATION(S)

This application claims priority to Chinese Application No. 202510320530.2 filed on March 18, 2025, the disclosure of which is incorporated herein by reference in its entirety.

### FIELD

Embodiments of the present disclosure generally relate to the field of live streaming, and in particular, to a method, an apparatus, a device, a medium, and a program product for processing a video stream.

### BACKGROUND

At present, in the field of live streaming, in addition to the interaction between a streamer and a guest, between the streamer and an audience, and between the guest and the audience, interactive play methods are becoming more and more popular and are also increasingly loved by different groups of people. Common interactive play methods may bring an active atmosphere to the streamer, the guest and the audience, and may even be used for socializing and become a bridge for communication between people. In other more flexible interactive play methods, in particular, some play methods that allow the audience, guests, etc. to join the live room for interesting interaction anytime and anywhere are more popular. In addition to the interestingness brought about by the interaction itself, the communication between the streamer, the guest and the audience is also increased, the atmosphere of the entire live room is activated, and the enthusiasm and live streaming experience of the streamer, the guest and the audience are improved.

### SUMMARY

Embodiments of the present disclosure provide a method, an apparatus, a device, a medium, and a program product for processing a video stream.

According to a first aspect of the present disclosure, there is provided a method for processing a video stream. The method includes determining, at a client, a video stream for live streaming. The method further includes determining, based on a performance of the client, whether to adjust an attribute of a target video frame in the video stream. The method further includes adjusting a color value of a target pixel in the target video frame in response to determining to adjust the attribute of the target video frame. The method further includes displaying the target video frame with the adjusted target pixel in the video stream.

In a second aspect of the present disclosure, there is provided an apparatus for processing a video stream. The apparatus includes a video stream determination module configured to determine, at a client, a video stream for live streaming; an attribute adjustment determination module configured to determine, based on a performance of the client, whether to adjust an attribute of a target video frame in the video stream; a color value adjustment module configured to, adjust a color value of a target pixel in the target video frame in response to determining to adjust the attribute of the target video frame; and a target video frame displaying module configured to display the target video frame with the adjusted target pixel in the video stream.

In a third aspect of the present disclosure, there is provided an electronic device. The electronic device includes at least one processor; and a storage device for storing at least one program, the at least one program, when executed by the at least one processor, causes the at least one processor to implement the method according to the first aspect of the present disclosure.

In a fourth aspect of the present disclosure, there is provided a computer-readable storage medium having a computer program stored thereon, the program, when executed by a processor, implements the method according to the first aspect of the present disclosure.

In a fifth aspect of the present disclosure, there is provided a computer program product. The computer program product includes a computer program, the computer program, when executed by a processor, implements the method according to the first aspect of the present disclosure.

It should be understood that the content described in this section is not intended to identify key or important features of the embodiments of the present disclosure, nor is it intended to limit the scope of the present disclosure. Other features of the present disclosure will become readily understood through the following description.

### BRIEF DESCRIPTION OF THE DRAWINGS

The above and other objects, features, and advantages of the present disclosure will become more apparent by describing the exemplary embodiments of the present disclosure in more detail in conjunction with the drawings, in which the same reference numerals generally represent the same components in the exemplary embodiments of the present disclosure.

FIG. 1 illustrates a schematic diagram of an example environment in which the device and/or method of some embodiments of the present disclosure may be implemented;

FIG. 2 illustrates a schematic diagram of an example method for processing a video stream according to some embodiments of the present disclosure;

FIG. 3 illustrates a schematic diagram of an example of a flowchart for processing a video stream according to some embodiments of the present disclosure;

FIG. 4 illustrates a schematic diagram of an example of another flowchart for processing a video stream according to some embodiments of the present disclosure;

FIG. 5 illustrates a schematic diagram of an example of another flowchart for processing a video stream according to some embodiments of the present disclosure;

FIG. 6 illustrates a schematic diagram of an example of another flowchart for processing a video stream according to some embodiments of the present disclosure;

FIG. 7 illustrates a schematic diagram of an example of an image link for processing a video stream according to some embodiments of the present disclosure;

FIG. 8 illustrates a schematic block diagram of an apparatus for processing a video stream according to some embodiments of the present disclosure; and

FIG. 9 illustrates a schematic block diagram of an example device suitable for implementing multiple embodiments of the present disclosure.

In each figure, the same or corresponding reference numerals represent the same or corresponding parts.

### DETAILED DESCRIPTION OF EMBODIMENTS

It can be It may be understood that the data involved in the technical solution (including but not limited to the data itself, acquisition or use of the data) shall comply with requirements of corresponding laws, regulations, and related provisions.

It may be understood that before using the technical solutions disclosed in the embodiments of the present disclosure, the user shall be informed of the type, range of use, use scenarios, etc., of personal information involved in the present disclosure in an appropriate manner and the authorization of the user shall be obtained in accordance with relevant laws and regulations.

For example, when an active request of the user is received, prompt information is sent to the user to clearly inform the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative and does not limit the implementations of the present disclosure, and other manners that satisfy the relevant laws and regulations may also be applied in the implementations of the present disclosure.

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "an embodiment" or "the embodiment" should be understood as "at least one embodiment". The terms "first", "second", etc. may refer to different or same objects. Other definitions, either explicit or implicit, may also be included below.

In today's live streaming scenarios, the picture quality of video streams transmitted during live streaming has been paid more and more attention, and has become an important reference indicator for improving the popularity of live rooms and the length of stay in live rooms. In the process of multi-person live streaming, pictures displayed by a streamer or a guest are from the decoding of a real-time communication stream published by a subscribed cloud game, and there is a process from encoding to transmission and then to decoding in this link, which is usually accompanied by picture quality loss. Therefore, there is a certain picture quality degradation in the pictures displayed by the streamer or the guest compared with the original image during game rendering, which leads to a decline in the quality of the video stream received by the streamer, the guest and even the audience, seriously affecting the viewing experience in the live room, and may lead to a decline in the popularity of the live room and even a decrease in the number of people in the live room. In a traditional solution, in a solution for multi-person live streaming (for example, a multi-person live streaming cloud game), a solution of single room, multiple users and one stream is used. Therefore, for users (such as the streamer and the guest) who join a cloud game, the pictures previewed locally are from the same real-time communication stream published by a cloud game server, so as to reduce the quality gap of pictures seen by different users as much as possible, thereby improving the live streaming viewing experience of users using different devices.

However, in practical applications, due to the inconsistency in the type and performance of devices used by different users, and the picture quality degradation of video streams in a transmission link, when a client receives a transmitted video stream, there has been a problem of picture quality degradation in the pictures. At the same time, due to problems such as the performance or type of the device, the video stream may not be completely correctly presented to the user in the best quality, which makes it impossible to obtain the optimal display effect on different devices under a single transmission link.

Nowadays, with the gradual upgrading of interactive play methods, people's requirements for the quality of video streams transmitted during live streaming have become higher and higher. High-quality video streams may make the streamer, the guest and the audience more willing to stay in the live room for interaction, and may also improve the visual experience of each party when watching live streaming, which plays an important role in maintaining the popularity of the live room and the live streaming effect. Therefore, improving the quality of video streams during live streaming has become a research topic that has attracted more and more attention.

At least in order to solve the above and other potential problems, embodiments of the present disclosure provide a method for processing a video stream. In this method, a computing device may first determine, at a client, a video stream for live streaming, where the video stream is obtained by decoding an original video stream. Next, after obtaining the video stream, the client determines whether to adjust an attribute of a target video frame in the video stream based on a performance of the client. Then, after determining that the attribute of the target video frame needs to be adjusted, a color value of a target pixel in the target video frame is adjusted. Finally, the computing device displays, in the client, the target video frame with the adjusted target pixel in the video stream. Through this method, the adjustment of the attribute of the target video frame of the video stream is moved down from a streaming-pushing end to a streaming-pulling client, which greatly reduces the problem of picture quality degradation caused by the video stream during transmission, and may adjust the attribute of the target video frame in the video stream according to the performance of different devices, reduces the display difference of pictures between different devices as much as possible, and improves the experience of users watching live streaming.

It may be understood that the present disclosure is only described in combination with related embodiments, and the related embodiments are not used to limit the protection scope of the present disclosure, and any technical solution in other disclosures that falls within the protection scope of the present disclosure shall be protected.

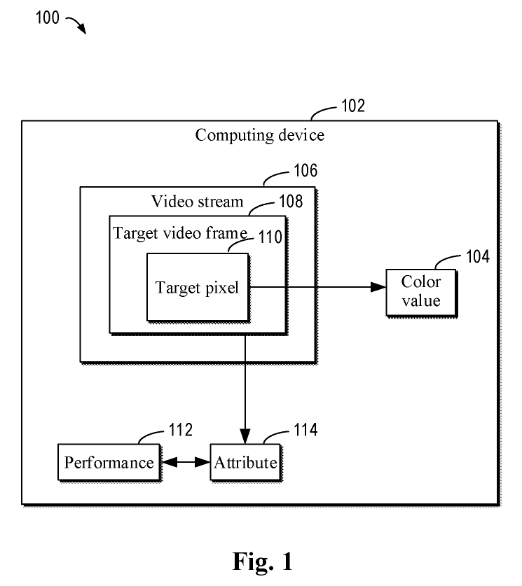

Hereinafter, embodiments of the present disclosure will be further described in detail with reference to the drawings. FIG. 1 illustrates an example environment in which the device and/or method of the embodiments of the present disclosure may be implemented. In environment 100, a computing device 102 may be a client, and processing on a video stream is completed at the client. For example, in a live streaming scenario, the computing device 102 is a client for a streamer or a client for a guest. In addition, the computing device 102 may further obtain the performance of the device itself, and determine whether to adjust the target video frame in the video stream based on the performance.

Examples of the computing device 102 include, but are not limited to, a personal computer, a server computer, a handheld or laptop device, a mobile device (such as a mobile phone, a personal digital assistant (PDA), a media player, etc.), a multi-processor system, a consumer electronic product, a minicomputer, a mainframe computer, a distributed computing environment including any of the above systems or devices, etc.

As shown in FIG. 1, the computing device 102 may determine a video stream 106 for live streaming. Among them, the video stream 106 is obtained by the computing device 102 by processing an original video stream received via a real time communication (RTC) transmission channel. For example, the video stream 106 is obtained by decoding the original video stream. In one example, the video stream is a video stream of a cloud game from a cloud game server.

Next, after obtaining the video stream 106 for live streaming, the computing device 102 further determines a performance 112 of the computing device 102, and determines whether to adjust an attribute 114 of a target video frame 108 in the video stream 106 based on the obtained performance 112.

After determining that the performance 112 of the device itself satisfies a condition that a video frame in the video stream may be adjusted, the computing device 102 may further determine to adjust the attribute 114 of the target video frame 108 in the video stream 106 accordingly. In addition, if the performance does not satisfy the condition that the video frame in the video stream may be adjusted, the attribute 114 of the target video frame 108 is not adjusted.

Then, after determining that the attribute 114 of the target video frame 108 needs to be adjusted, the computing device 102 adjusts a color value 104 of a target pixel 110 in the target video frame 108. Thus, the attribute 114 of the target video frame 108 is adjusted by adjusting the color value 104 of the target pixel 110 in the target video frame 108. Among them, the adjustment of the color value 104 may be performed in a first color space or a second color space, and the first color space is different from the second color space.

The adjustment for the color value 104 affects the change for the attribute 114 of the target video frame 108, for example, after the color value 104 of the target pixel 110 is adjusted, the sharpness, color, etc. included in the attribute 114 may be adjusted accordingly.

Finally, after the adjustment of the color value 104 of the target pixel 110 in the target video frame 108 is completed, the video stream 106 including the target video frame 108 with the adjusted target pixel 110 is displayed on a display screen of the computing device 102 as the client.

Through this method, the adjustment of the attribute of the target video frame of the video stream is moved down from a streaming-pushing end to a streaming-pulling client, which greatly reduces the problem of picture quality degradation caused by the video stream during transmission, and may adjust the attribute of the target video frame in the video stream according to the performance of different devices, reduces the display difference of pictures between different devices as much as possible, and improves the experience of users watching live streaming.

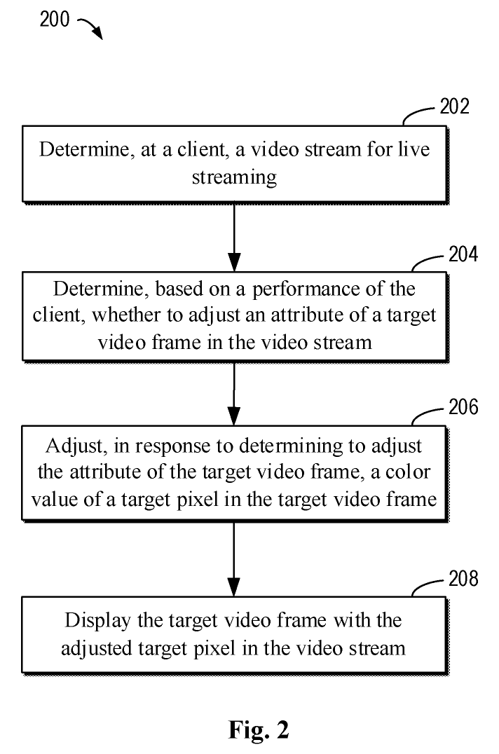

The schematic diagram of the example environment in which the device and/or method of some embodiments of the present disclosure may be implemented is described above with reference to FIG. 1, and the schematic diagram of an example method 200 for processing a video stream according to some embodiments of the present disclosure is described below with reference to FIG. 2. The example method may be performed by the computing device 102 in FIG. 1 or any suitable computing device.

As shown in FIG. 2, in the example method 200, at block 202, a video stream for live streaming is determined at a client. Among them, the client may be the computing device 102 in FIG. 1. Among them, the video stream 106 is obtained by processing an original video stream for the video stream 106. For example, the computing device 102 obtains the video stream 106 by decoding the original video stream. Since the decoded video stream has a problem of picture quality degradation, picture quality enhancement needs to be performed on the decoded video stream at the client, for example, a video frame in the video stream is adjusted accordingly to enhance the picture quality.

In one example, the original video stream may be generated at another client. In another example, the original video stream may be generated at a server, for example, the original video stream is generated at a cloud game server. In addition, the original video stream may be transmitted to the computing device 102 via a transmission channel, for example, the original video stream may be transmitted to the computing device 102 via an RTC transmission channel.

Next, at block 204, whether to adjust an attribute of a target video frame in the video stream is determined based on a performance of the client. For example, the performance of the computing device 102 may be represented by a performance score.

In some embodiments, a scoring model for the performance score of the computing device 102 may be used to obtain the performance score of the computing device 102, for example, a machine learning model may be used to obtain a parameter of the computing device 102, and the performance score of the computing device 102 is determined based on the obtained parameter. The parameter of the computing device 102 may include information such as a processor model and a memory size. Subsequently, when it is determined that the performance score is greater than a threshold score, it may be determined that the performance 112 of the computing device 102 meets a requirement, and it is determined that the attribute 114 of the target video frame 108 in the video stream 106 may be adjusted accordingly. In addition, the training of the machine learning model for calculating the performance score may be adjusted by the user according to an actual situation, which is not limited in the present application.

In another example, the performance score of the computing device 102 may also be determined according to a preset method for calculating the performance score. For example, the performance score of the computing device 102 may be determined according to a preset calculation function for the performance score, the calculation function may include various parameters for calculation, and the parameters may be obtained using the computing device 102. In addition, the calculation function may be set by the user according to the actual situation, which is not limited in the present application.

In some embodiments, in addition to determining whether to adjust the attribute 114 of the target video frame 108 in the video stream 106 based on the performance 112 of the computing device 102, whether to adjust the attribute 114 of the target video frame 108 in the video stream 106 may also be determined based on a device type of the computing device 102.

In one example, the computing device 102 first obtains a group of device types of a group of devices having a target performance available for adjusting the attribute 114, and then determines whether the device type of the computing device 102 belongs to one of a group of device types. If the device type of the computing device 102 belongs to one of a group of device types, it indicates that the computing device 102 has the target performance.

For example, when it is determined that the device type of the computing device 102 belongs to one of a group of device types, it may be determined that the attribute 114 of the target video frame 108 in the video stream 106 may be adjusted on the computing device 102. In addition, when the device type of the computing device 102 does not belong to one of a group of device types, it is determined not to adjust the attribute 114 of the target video frame 108 in the video stream 106.

In addition, the attribute 114 of the target video frame 108 in the video stream 106 may be determined to be adjusted only when the performance score of the performance 112 of the computing device 102 reaches the threshold score and the device type of the computing device 102 belongs to one of a group of device types.

After determining that the performance 112 reaches the standard, the computing device 102 may further determine to adjust the attribute 114 of the target video frame 108 in the video stream 106 accordingly. In addition, if the performance does not reach the standard, the attribute 114 is not adjusted.

Then, at block 206, in response to determining to adjust the attribute of the target video frame, a color value of a target pixel in the target video frame is adjusted. For example, the attribute 114 may include multiple attributes, such as brightness, sharpness, color, and contrast.

In some embodiments, the adjustment for the attribute 114 needs to be performed in different color spaces. For example, the adjustment of a grayscale value in the attribute 114 may be performed in the second color space, and the adjustment of contrast, color, etc. in the attribute 114 may be performed in the first color space. Among them, the first color space is a red green blue (RGB) color space, and the second color space is a luminance-blue chrominance-red chrominance (YCbCr) color space. In addition, the computing device 102 may switch the color space between the first color space and the second color space. In addition, the first color space and the second color space may be any color spaces that may implement the solution, which is not limited in the present application.

Subsequently, after determining that the attribute 114 of the target video frame 108 in the video stream 106 may be adjusted accordingly, the color value of the target pixel 110 in the target video frame 108 is further adjusted.

In some embodiments, the computing device 102 further obtains a texture length and a texture width of a texture of the target video frame 108, and determines a pixel step size for the target pixel 110 using the obtained texture length and texture width, and then may determine a group of pixels for the target pixel 110 based on the determined pixel step size in combination with the target pixel 110. In one example, the obtained texture length and texture width are used to determine the pixel step size for the target pixel 110, for example, 8 pixel step sizes may be obtained, and 8 pixels located around the target pixel 110 are determined based on the obtained 8 pixel step sizes. In addition, the calculation of the pixel step size may be defined by the user, which is not limited in the present application.

Subsequently, the computing device 102 may obtain the color value of the target pixel 110 and a group of color values of a group of pixels located around the target pixel 110. In addition, the color value of the target pixel 110 and a group of color values of the group of pixels located around the target pixel 110 are obtained in the first color space. It should be noted that the number of the group of pixels located around the target pixel 110 may be defined by the user, which is not limited in the present application.

Subsequently, the computing device 102 converts the color value of the target pixel 110 and a group of color values of a group of pixels located around the target pixel 110 from the first color space to the second color space, and then determines a grayscale value of a luminance component for the target pixel 110 and a group of grayscale values of luminance components for a group of pixels in the second color space. After obtaining the grayscale value of the luminance component for the target pixel and a group of grayscale values of the luminance components for a group of pixels, the grayscale value of the target pixel may also be adjusted.

In some embodiments, the computing device 102 determines a group of gradients corresponding to the target pixel 110 based on the grayscale value and a group of grayscale values. For example, a grayscale gradient is calculated by a difference between the grayscale of the target pixel and the grayscale of one pixel in a group of pixels in combination with a distance between the two pixels. Then, a maximum gradient in a group of gradients is further determined, and then a sharpness parameter for adjusting the target video frame is also determined, and the grayscale value of the luminance component is adjusted using the obtained sharpness parameter and the maximum gradient.

Subsequently, after the grayscale value of the luminance component is adjusted, the color value of the target pixel 110 may also be updated using the adjusted luminance component to adjust the sharpness in the attribute 114 of the target video frame 108. For example, the target pixel having the adjusted luminance component is converted from the second color space to the first color space for the adjusted video stream 106 to be rendered on a screen at the computing device 102 for display.

In some embodiments, in addition to adjusting the sharpness in the attribute 114, the color in the attribute 114 may also be adjusted, and then the target video frame 108 with the adjusted attribute is rendered to display the adjusted video stream 106 in the computing device 102.

It is first determined that the target video frame 108 is located in the first color space, and then a denormalization operation is performed on the color value 104 of the target pixel 110 in the target video frame 108. For example, the first color space is mapped from a first range to a second range. In one example, the first color space is mapped from a first range [0, 1.0] to a second range [-0.5, 0.5].

Subsequently, a contrast parameter for the target video frame 108 is further obtained, and the denormalized color value 104 is adjusted using the obtained contrast parameter. In one example, when the first color space is an RGB color space, three color value components of R, G, and B corresponding to the color value 104 are calculated, for example, multiplied, with the contrast parameter respectively, to obtain an adjusted color value, and then the adjusted color value is renormalized, that is, the first color space is remapped from the second range [-0.5, 0.5] to the first range [0, 1.0].

A brightness parameter for the target video frame 108 may also be obtained, and the renormalized color value is adjusted based on the obtained brightness parameter, for example, the brightness parameter is added to the renormalized color value. Then, the target video frame 108 with the adjusted attribute may be rendered to display the adjusted video stream 106 in the computing device 102.

It should be noted that the adjustment of the sharpness in the attribute 114 of the target video frame 108 or the adjustment of the color in the attribute 114 of the target video frame 108 may be performed separately. In addition, the adjustment of the sharpness in the attribute 114 of the target video frame 108 or the adjustment of the color in the attribute 114 of the target video frame 108 may be performed serially. In one example, the computing device may first determine whether the performance score of the computing device 102 is greater than a first threshold score and/or whether the type of the computing device 102 belongs to a first group of device types. If it is determined that the performance score of the computing device 102 is greater than the first threshold score and/or the type of the computing device 102 belongs to the first group of device types, the sharpness in the attribute 114 may be adjusted first. The computing device may then determine whether the performance score of the computing device 102 is greater than a second threshold score and/or whether the type of the computing device 102 belongs to a second group of device types. If it is determined that the performance score of the computing device 102 is greater than the second threshold score and/or the type of the computing device 102 belongs to the second group of device types, the color in the attribute 114 is adjusted. In addition, the first threshold score and the second threshold score may be the same or different; the first group of device types and the second group of device types may be the same, different, or partially the same. In another example, the color in the attribute 114 may be adjusted first, and then the sharpness in the attribute 114 may be adjusted. In yet another example, the adjustment of the sharpness and color of the attribute 114 may be performed in parallel, and the adjustment of the sharpness and the adjustment of the color may be performed in different color spaces at the same time. The conditions for determining whether to perform attribute adjustment in the above examples may be the same or different.

The execution order of the adjustment of the sharpness and the adjustment of the color in the attribute 114 may be defined by the user, which is not limited in the present application.

Finally, at block 208, the target video frame with the adjusted target pixel in the video stream is displayed.

It should be noted that after the computing device 102 receives the video stream 106, the adjustment of the attribute 114 of the target pixel 110 of the target video frame 108 in the video stream 106 is performed at the computing device 102, and the adjusted target video frame 108 may be re-rendered as the video stream 106 and displayed on the display screen of the computing device 102.

Through this method, the adjustment of the attribute of the target video frame of the video stream is moved down from a streaming-pushing end to a streaming-pulling client, which greatly reduces the problem of picture quality degradation caused by the video stream during transmission, and may adjust the attribute of the target video frame in the video stream according to the performance of different devices, reduces the display difference of pictures between different devices as much as possible, and improves the experience of users watching live streaming.

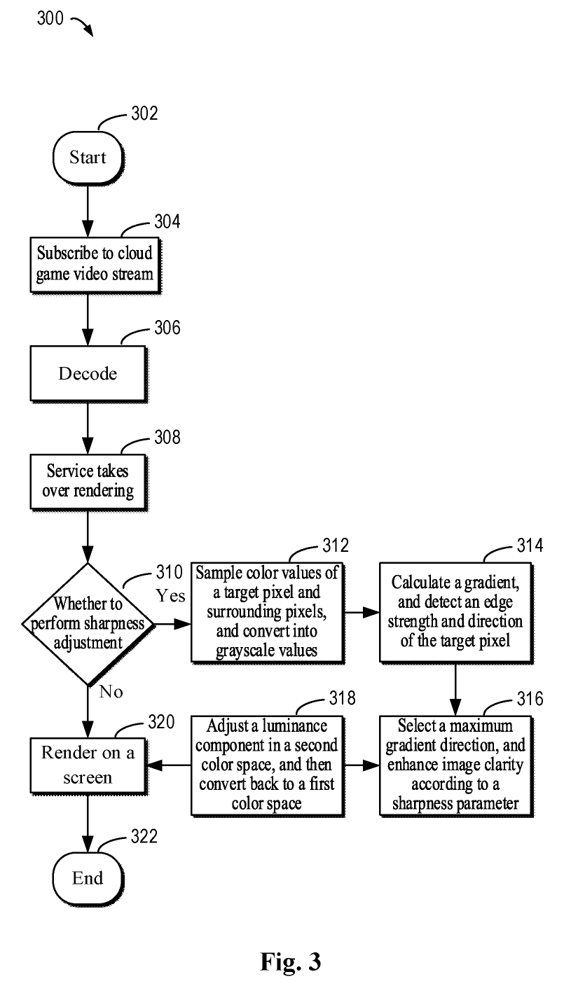

The schematic diagram of the example method for processing a video stream according to some embodiments of the present disclosure is described above with reference to FIG. 2, and the schematic diagram of an example of a flowchart for processing a video stream according to some embodiments of the present disclosure is described below with reference to FIG. 3.

As shown in example 300 in FIG. 3, taking a multi-person live streaming cloud game in a live streaming scenario as an example, after live streaming starts 302, the client needs to subscribe to a cloud game video stream at 304. After receiving the subscribed cloud game video stream (hereinafter referred to as a video stream), the client decodes the received video stream at 306, and then performs service takeover rendering of the decoded video stream at 308.

After the rendering is taken over by the service in the client, since the decoded video stream has a problem of picture quality degradation, picture quality enhancement needs to be performed on the decoded video stream at the client.

Subsequently, at 310, whether to perform sharpness adjustment is determined, and after it is determined that the sharpness adjustment is to be performed, at 312, color values of a target pixel and surrounding pixels are sampled and converted into grayscale values. Among them, the color values of the target pixel and the surrounding pixels are sampled in a first color space.

Subsequently, at 314, a gradient is calculated to detect an edge strength and direction of the target pixel, and based on the calculated edge strength and direction, a maximum gradient direction may be further selected at 316, and image clarity is enhanced according to a sharpness parameter. Among them, a gradient size of the target pixel is different from that of a group of pixels around the target pixel. In addition, the process of adjusting the sharpness is implemented in a second color space.

Next, at 318, a luminance component is adjusted in the second color space and then converted back to the first color space. After the color space is converted back to the first color space, at 320, a video stream in which the target pixel with the adjusted sharpness is located is rendered on a screen.

Finally, the video stream in which the video frame with the adjusted sharpness is located is displayed on the client, and the process ends at 322.

If it is determined not to perform the sharpness adjustment, the video stream is directly rendered on the screen at 320, and the process ends at 322.

Through this method, the adjustment of the sharpness of the target video frame of the video stream is moved down from a streaming-pushing end to a streaming-pulling client, which greatly reduces the problem of picture quality degradation caused by the video stream during transmission, and improves the experience of users watching live streaming.

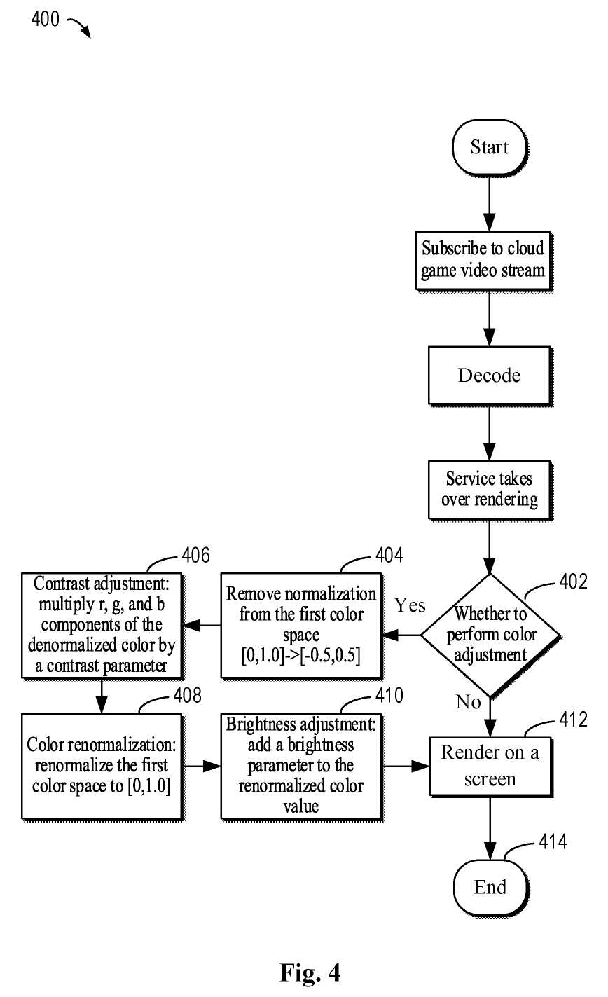

The schematic diagram of the example of the flowchart for processing a video stream according to some embodiments of the present disclosure is described above with reference to FIG. 3, and the schematic diagram of the example of another flowchart for processing a video stream according to some embodiments of the present disclosure is described below with reference to FIG. 4.

As shown in FIG. 4, in example 400, in combination with previous example 300, after the rendering is taken over by the service in the client, it is determined at 402 whether to perform color adjustment, and after it is determined that the color adjustment is to be performed, at 404, normalization is removed from the first color space, that is, the first color space is denormalized, and a range of the first color space is mapped from a first range [0, 1.0] to a second range [-0.5, 0.5].

Next, at 406, contrast adjustment is performed, and r, g, and b components of the denormalized color are multiplied by a contrast parameter. Subsequently, at 408, the color is renormalized, and the first color space is renormalized to [0, 1.0], that is, the first color space is remapped from the second range [-0.5, 0.5] to the first range [0, 1.0].

Then, at 410, brightness adjustment is performed, a brightness parameter is added to the renormalized color value, and at 412, a video stream in which a target pixel with the adjusted color is located is rendered on a screen. The process then ends at 414.

If it is determined not to perform the color adjustment, the video stream is directly rendered on the screen at 412, and the process ends at 414.

Through this method, the adjustment for the color of the target video frame of the video stream is moved down from the streaming-pushing end to the streaming-pulling client, which greatly reduces the problem of picture quality degradation caused by the video stream during transmission, and improves the experience of users watching live streaming.

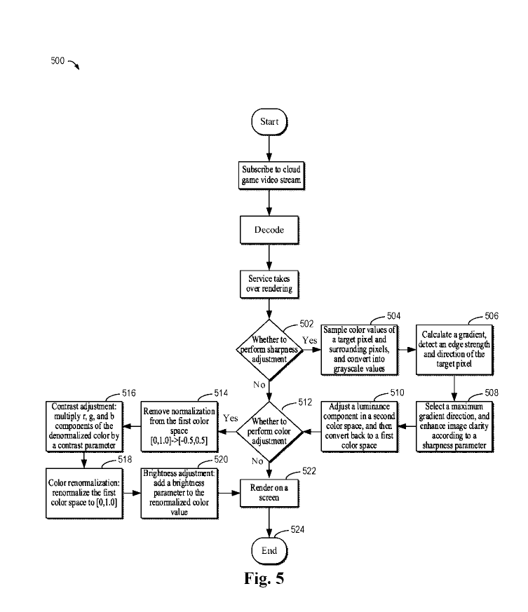

The schematic diagram of the example of another flowchart for processing a video stream according to some embodiments of the present disclosure is described above with reference to FIG. 4, and the schematic diagram of the example of yet another flowchart for processing a video stream according to some embodiments of the present disclosure is described below with reference to FIG. 5. This example may be executed by the computing device 102 in FIG. 1 or any suitable device as the client.

As shown in FIG. 5, in example 500, in combination with previous example 300 and example 400, after the rendering is taken over by the service in the client, it is first determined at 502 whether to perform sharpness adjustment, and after it is determined that the sharpness adjustment is to be performed, at 504, color values of a target pixel and surrounding pixels are sampled and converted into grayscale values. The color values of the target pixel and the surrounding pixels are sampled in a first color space.

Subsequently, at 506, a gradient is calculated to detect an edge strength and direction of the target pixel, and based on the calculated edge strength and direction, a maximum gradient direction may be further selected at 508, and image clarity is enhanced according to a sharpness parameter. Among them, a gradient size of the target pixel is different from that of a group of pixels around the target pixel. In addition, the process of adjusting the sharpness is implemented in a second color space.

Next, at 510, a luminance component is adjusted in the second color space and then converted back to the first color space. After the color space is converted back to the first color space, it is further determined at 512 whether to perform color adjustment, and after it is determined that the color adjustment is to be performed, at 514, normalization is removed from the first color space, that is, the first color space is denormalized, and a range of the first color space is mapped from a first range [0, 1.0] to a second range [-0.5, 0.5].

Next, at 516, contrast adjustment is performed, and r, g, and b components of the denormalized color are multiplied by a contrast parameter. Subsequently, at 518, the color is renormalized, and the first color space is renormalized to [0, 1.0], that is, the first color space is remapped from the second range [-0.5, 0.5] to the first range [0, 1.0].

Then, at 520, brightness adjustment is performed, a brightness parameter is added to the renormalized color value, and at 522, a video stream in which a target pixel with the adjusted color is located is rendered on a screen. The process then ends at 524.

If it is determined not to perform both the sharpness adjustment and the color adjustment, the video stream is directly rendered on the screen at 522, and the process ends at 524.

Through this method, the adjustment of the sharpness and color of the target video frame of the video stream is moved down from a streaming-pushing end to a streaming-pulling client, which greatly reduces the problem of picture quality degradation caused by the video stream during transmission, reduces the display difference of pictures between different devices as much as possible, and improves the experience of users watching live streaming.

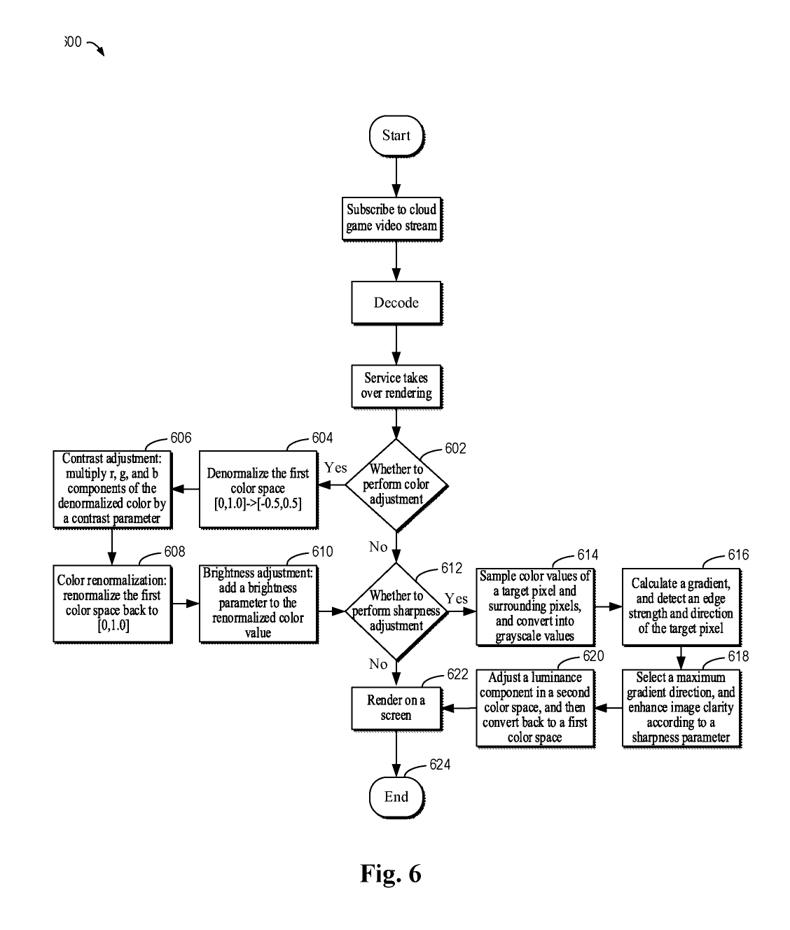

The schematic diagram of the example of yet another flowchart for processing a video stream according to some embodiments of the present disclosure is described above with reference to FIG. 5, and the schematic diagram of the example of still another flowchart for processing a video stream according to some embodiments of the present disclosure is described below with reference to FIG. 6.

As shown in FIG. 6, in example 600, in combination with previous example 500, it is first determined at 602 whether to perform color adjustment, and after it is determined that the color adjustment is to be performed, at 604, normalization is removed from the first color space, that is, the first color space is denormalized, and a range of the first color space is mapped from a first range [0, 1.0] to a second range [-0.5, 0.5].

Next, at 606, contrast adjustment is performed, and r, g, and b components of the denormalized color are multiplied by a contrast parameter. Subsequently, at 608, the color is renormalized, and the first color space is renormalized to [0, 1.0], that is, the first color space is remapped from the second range [-0.5, 0.5] to the first range [0, 1.0].

Then, at 610, brightness adjustment is performed, and a brightness parameter is added to the renormalized color value. Subsequently, at 612, whether to perform sharpness adjustment is determined, and after it is determined that the sharpness adjustment is to be performed, at 614, color values of a target pixel and surrounding pixels are sampled and converted into grayscale values. Among them, the color values of the target pixel and the surrounding pixels are sampled in a first color space.

Subsequently, at 616, a gradient is calculated to detect an edge strength and direction of the target pixel, and based on the calculated edge strength and direction, a maximum gradient direction may be further selected at 618, and image clarity is enhanced according to a sharpness parameter. Among them, a gradient size of the target pixel is different from that of a group of pixels around the target pixel. In addition, the process of adjusting the sharpness is implemented in a second color space.

Next, at 620, a luminance component is adjusted in the second color space and then converted back to the first color space. After the color space is converted back to the first color space, a video stream with the adjusted sharpness is rendered on a screen at 622, and the process ends at 624.

If it is determined not to perform both the sharpness adjustment and the color adjustment, the video stream is directly rendered on the screen at 622, and the process ends at 624.

Through this method, the adjustment for the sharpness and color of the target video frame of the video stream is moved down from a streaming-pushing end to a streaming-pulling client, which greatly reduces the problem of picture quality degradation caused by the video stream during transmission, reduces the display difference of pictures between different devices as much as possible, and improves the experience of users watching live streaming.

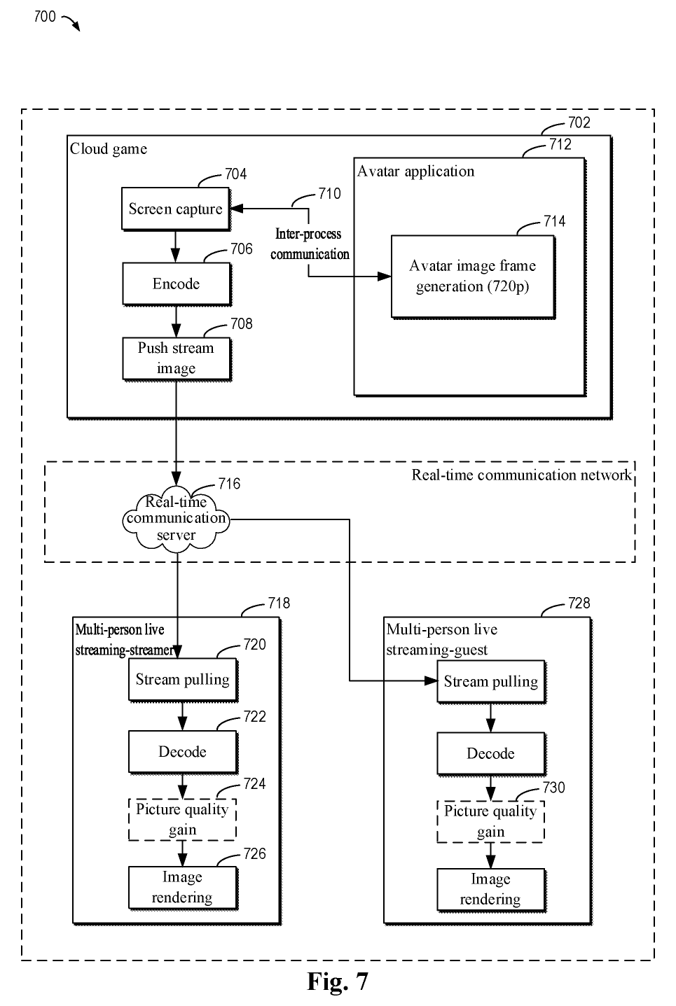

The schematic diagram of the example of still another flowchart for processing a video stream according to some embodiments of the present disclosure is described above with reference to FIG. 6, and the schematic diagram of the example of the image link for processing a video stream according to some embodiments of the present disclosure is described below with reference to FIG. 7.

As shown in FIG. 7, in example 700, taking a live streaming multi-person cloud game in a live streaming scenario as an example, a cloud game 702 includes an avatar application 712, and an avatar may be generated in the avatar application 712. For example, at 714, avatar image frame generation may be performed, where a resolution of the generated image frame is 720p. In addition, the resolution of the generated image frame may be determined based on the performance of the device running the cloud game, or may be a preset resolution.

Next, at 710, through inter-process communication, screen capture is performed on the generated avatar image frame at 704, and then the captured image frame is encoded at 706 to generate a video stream.

Subsequently, at 708, a video stream image is pushed to a server, and the video stream is pushed to a multi-person live streaming-streamer 718 end, that is, pushed to the client, via a real-time communication server 716. The streamer end pulls the video stream at 720 via the real-time communication server 716, and decodes the pulled video stream at 722.

Subsequently, at 724, picture quality gain is performed on the decoded video stream, and the video stream whose picture quality is degraded due to the transmission process is adjusted to reduce the impact caused by the picture quality degradation.

Finally, image rendering is performed on the video stream with the picture quality gain at 726 to display the adjusted video stream at the client.

At a multi-person live streaming-guest 728, the video stream is also pulled via the real-time communication server 716, the pulled video stream is decoded, and the picture quality gain is also performed on the decoded video stream at 730, and then the adjusted video stream is rendered at the client to be displayed on a display screen of the client.

Through this method, the adjustment of the attribute of the target video frame of the video stream is moved down from a streaming-pushing end to a streaming-pulling client, which greatly reduces the problem of picture quality degradation caused by the video stream during transmission, reduces the display difference of pictures between different devices as much as possible, and improves the experience of users watching live streaming.

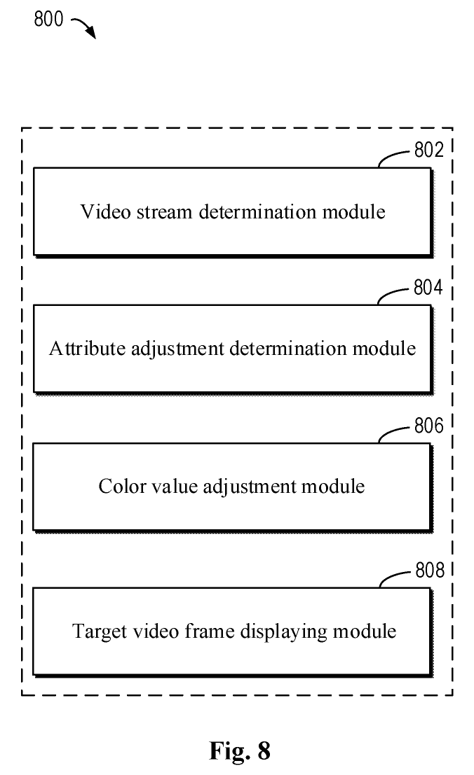

As shown in FIG. 8, the apparatus 800 includes a video stream determination module 802 configured to determine, at a client, a video stream for live streaming; an attribute adjustment determination module 804 configured to determine, based on a performance of the client, whether to adjust an attribute of a target video frame in the video stream; a color value adjustment module 806 configured to, adjust a color value of a target pixel in the target video frame in response to determining to adjust the attribute of the target video frame; and a target video frame displaying module 808 configured to display the target video frame with the adjusted target pixel in the video stream.

In some embodiments, the video stream determination module 802 includes: an original video stream receiving module configured to receive, at the client, an original video stream for live streaming; and an original video stream decoding module configured to determine the video stream for live streaming by decoding the original video stream.

In some embodiments, the attribute adjustment determination module 804 includes: a performance score determination module configured to determine a performance score for the performance of the client; and an attribute adjustment determination module configured to, determine to adjust the attribute of the target video frame in the video stream in response to the performance score being greater than a threshold score.

In some embodiments, the attribute adjustment determination module 804 includes: a group of device types determination module configured to determine a group of device types of a group of devices having a target performance available for adjusting an attribute of a video frame in the video stream; and an attribute adjustment determination module configured to, determine that the client has the target performance for adjusting the attribute of the target video frame in the video stream in response to a type of the client belonging to the group of device types.

In some embodiments, the attribute includes sharpness, the color value is a color value of the target pixel in a first color space, and the color value adjustment module 806 includes: a color value and a group of color values obtaining module configured to obtain the color value of the target pixel and a group of color values of a group of pixels located around the target pixel in the first color space; a grayscale value and a group of grayscale values determination module configured to determine, based on the color value and the group of color values, a grayscale value of a luminance component for the target pixel and a group of grayscale values of luminance components for the group of pixels in a second color space; a grayscale value adjustment module configured to adjust the grayscale value of the luminance component based on the grayscale value and the group of grayscale values; and a color value update module configured to update the color value of the target pixel in the target video frame based on the adjusted luminance component to adjust the sharpness of the target video frame.

In some embodiments, the grayscale value adjustment module includes: a group of gradients determination module configured to determine a group of gradients corresponding to the target pixel based on the grayscale value and the group of grayscale values; a sharpness parameter determination module configured to determine a sharpness parameter for adjusting the target video frame; and a grayscale value adjustment module configured to adjust the grayscale value of the luminance component based on a maximum gradient in the group of gradients and the sharpness parameter.

In some embodiments, the color value update module includes: a color space conversion module configured to update the color value of the target pixel by performing color space conversion on the adjusted luminance component.

In some embodiments, the color value adjustment module 806 further includes: a texture length and texture width obtaining module configured to obtain a texture length and a texture width of a texture for the target video frame; a pixel step size determination module configured to determine a pixel step size for the target pixel based on the texture width and the texture length; and a group of pixels determination module configured to determine the group of pixels based on the pixel step size and the target pixel.

In some embodiments, the attribute includes color, and the color value adjustment module 806 further includes: a denormalization module configured to denormalize the color value of the target pixel in the target video frame; a contrast parameter obtaining module configured to obtain a contrast parameter for the target video frame; a denormalized color value adjustment module configured to adjust the denormalized color value based on the contrast parameter; a renormalization module configured to renormalize the adjusted color value; a brightness parameter obtaining module configured to obtain a brightness parameter for the target video frame; and a normalized color value adjustment module configured to adjust the normalized color value based on the brightness parameter.

In some embodiments, the denormalization module includes: a color value mapping module configured to map the color value of the target pixel from a first range to a second range, the second range being different from the first range.

In some embodiments, the target attribute includes at least one of: displacement, transparency, and scaling.

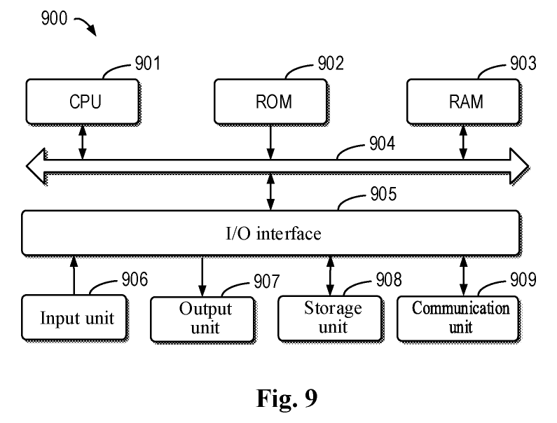

FIG. 9 illustrates a schematic block diagram of an example device 900 that may be used to implement the embodiments of the present disclosure. The computing device 102 in FIG. 1 may be implemented using the device 900. As shown in the figure, the device 900 includes a central processing unit (CPU) 901, which may perform various appropriate actions and processes based on computer program instructions stored in a read-only memory (ROM) 902 or computer program instructions loaded from a storage unit 908 into a random access memory (RAM) 903. In the RAM 903, various programs and data required for operations of the device 900 may also be stored. The CPU 901, the ROM 902, and the RAM 903 are connected to each other through a bus 904. An input/output (I/O) interface 905 is also connected to the bus 904.

Multiple components in the device 900 are connected to the I/O interface 905, and the components include: an input unit 906, such as a keyboard, a mouse, etc.; an output unit 907, such as various types of displays, speakers, etc.; the storage unit 908, such as a magnetic disk, an optical disc, etc.; and a communication unit 909, such as a network card, a modem, a wireless communication transceiver, etc. The communication unit 909 allows the device 900 to exchange information/data with other devices over a computer network such as Internet and/or various telecommunication networks.

The various processes and treatments described above, such as the method 200 and examples 300 to 700, may be performed by a processing unit 901. For example, in some embodiments, the method 200 and examples 300 to 700 may be implemented as a computer software program, which is tangibly contained in a machine-readable medium, such as the storage unit 908. In some embodiments, a portion or an entirety of the computer program may be loaded and/or installed into the device 900 via the ROM 902 and/or the communication unit 909. When the computer program is loaded into the RAM 903 and executed by the CPU 901, one or more actions of the example method 200 and examples 300 to 700 described above may be performed.

The present disclosure may be a method, an apparatus, a system, and/or a computer program product. The computer program product may include a computer-readable storage medium having computer-readable program instructions for performing various aspects of the present disclosure stored thereon.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanically encoded device, such as a punch card or a raised structure in a groove with instructions stored thereon, and any suitable combination of the foregoing. The computer-readable storage medium used herein is not interpreted as an instantaneous signal per se, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from a computer-readable storage medium to various computing/processing devices, or downloaded to an external computer or an external storage device via a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network, and forwards the computer-readable program instructions for storage in a computer-readable storage medium in the various computing/processing devices.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages such as Smalltalk, C++, etc., and conventional procedural programming languages such as "C" language or similar programming languages. The computer-readable program instructions may be executed entirely on a user computer, partly executed on a user computer, executed as an independent software package, partly executed on a user computer and partly executed on a remote computer, or entirely executed on a remote computer or a server. In the case of involving a remote computer, the remote computer may be connected to the user computer through any kind of network, including a local area network (LAN) or a wide area network (WAN), or it may be connected to an external computer (for example, connected via Internet using an Internet service provider). In some embodiments, by personalizing an electronic circuit, such as a programmable logic circuit, a field programmable gate array (FPGA) or a programmable logic array (PLA), using state information of the computer-readable program instructions, the electronic circuit may execute the computer-readable program instructions to implement various aspects of the present disclosure.

Various aspects of the present disclosure are described herein with reference to flowcharts and/or block diagrams of methods, apparatuses (systems), and computer program products according to embodiments of the present disclosure. It should be understood that each block of the flowcharts and/or block diagrams, and combinations of blocks in the flowcharts and/or block diagrams, may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing a specific function/action in one or more blocks of the flowcharts and/or block diagrams. These computer-readable program instructions may also be stored in a computer-readable storage medium, and these instructions cause a computer, a programmable data processing apparatus, and/or other devices to work in a specific manner, such that the computer-readable medium storing the instructions includes a manufactured product, which includes instructions for implementing various aspects of the specific function/action in one or more blocks of the flowcharts and/or block diagrams.

The computer-readable program instructions may also be loaded onto a computer, another programmable data processing apparatus, or another device, such that a series of operations and steps are performed on the computer, the another programmable data processing apparatus, or the another device, to produce a computer-implemented process, thereby causing the instructions executed on the computer, the another programmable data processing apparatus, or the another device to implement the specific function/action in one or more blocks of the flowcharts and/or block diagrams.

The flowcharts and block diagrams in the drawings show the possibly implemented architectures, functions, and operations of the system, the method, and the computer program product according to multiple embodiments of the present disclosure. In this regard, each block in the flowchart or block diagram may represent a module, program segment, or part of an instruction, and the module, program segment, or part of an instruction contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a special-purpose hardware-based system that executes specified functions or actions, or may be implemented by a combination of special-purpose hardware and computer instructions.

The embodiments of the present disclosure have been described above, and the above description is exemplary, non-exhaustive, and not limited to the disclosed embodiments. Without departing from the scope and spirit of the illustrated embodiments, many modifications and changes will be apparent to those of ordinary skill in the art. The terms used herein are selected to best explain the principles of the embodiments, the actual application or the technical improvement in the market, or to enable other persons of ordinary skill in the art to understand the embodiments disclosed herein.

We claim:

1. A method for processing a video stream, comprising:
determining, at a client, a video stream for live streaming;
determining, based on a performance of the client, whether to adjust an attribute of a video frame in the video stream;
adjusting a color value of a pixel in the video frame in response to determining to adjust the attribute of the video frame; and
displaying the video frame in the video stream having the adjusted pixel.

2. The method of claim 1, wherein determining, at the client, the video stream for the live streaming comprises:
receiving, at the client, an original video stream for the live streaming; and
determining the video stream for the live streaming by decoding the original video stream.

3. The method of claim 1, wherein determining whether to adjust the attribute of the video frame in the video stream comprises:
determining a performance score for the performance of the client; and
determining to adjust the attribute of the video frame in the video stream in response to the performance score being greater than a threshold score.

4. The method of claim 1, wherein determining whether to adjust the attribute of the video frame in the video stream comprises:
determining a group of device types of a group of devices having a performance available for adjusting an attribute of a video frame in the video stream; and
determining that the client has the performance for adjusting the attribute of the video frame in the video stream in response to a type of the client belonging to the group of device types.

5. The method of claim 1, wherein the attribute comprises sharpness, the color value is a color value of the pixel in a first color space, and adjusting the color value of the pixel in the video frame comprises:
obtaining the color value of the pixel and a group of color values of a group of pixels located around the pixel in the first color space;
determining, based on the color value and the group of color values, a grayscale value of a luminance component for the pixel and a group of grayscale values of luminance components for the group of pixels in a second color space;
adjusting the grayscale value of the luminance component based on the grayscale value and the group of grayscale values; and
updating the color value of the pixel in the video frame based on the adjusted luminance component to adjust the sharpness of the video frame.

6. The method of claim 5, wherein adjusting the grayscale value of the luminance component comprises:
determining a group of gradients corresponding to the pixel based on the grayscale value and the group of grayscale values;
determining a sharpness parameter for adjusting the video frame; and
adjusting the grayscale value of the luminance component based on a maximum gradient in the group of gradients and the sharpness parameter.

7. The method of claim 5, wherein updating the color value of the pixel in the video frame to adjust the sharpness of the video frame comprises:
updating the color value of the pixel by performing color space conversion on the adjusted luminance component.

8. The method of claim 5, wherein adjusting the color value of the pixel in the video frame further comprises:
obtaining a texture length and a texture width of a texture for the video frame;
determining a pixel step size for the pixel based on the texture width and the texture length; and
determining the group of pixels based on the pixel step size and the pixel.

9. The method of claim 1, wherein the attribute comprises color, and adjusting the color value of the pixel in the video frame comprises:
denormalizing the color value of the pixel in the video frame;
obtaining a contrast parameter for the video frame;
adjusting the denormalized color value based on the contrast parameter;
renormalizing the adjusted color value;
obtaining a brightness parameter for the video frame; and
adjusting the normalized color value based on the brightness parameter.

10. The method of claim 9, wherein denormalizing the color value of the pixel in the video frame comprises:
mapping the color value of the pixel from a first range to a second range, the second range being different from the first range.

11. The method of claim 1, wherein the video stream is a video stream for a cloud game.

12. An electronic device, comprising:
at least one processor; and
a storage device for storing at least one program, the at least one program, when executed by the at least one processor, causes the at least one processor to:
determine, at a client, a video stream for live streaming;
determine, based on a performance of the client, whether to adjust an attribute of a video frame in the video stream;
adjust a color value of a pixel in the video frame in response to determining to adjust the attribute of the video frame; and
display the video frame in the video stream having the adjusted pixel.

13. The electronic device of claim 12, wherein the at least one program causing the at least one processor to determine, at the client, the video stream for the live streaming comprises instructions to:
receive, at the client, an original video stream for the live streaming; and
determine the video stream for the live streaming by decoding the original video stream.

14. The electronic device of claim 12, wherein the at least one program causing the at least one processor to determine whether to adjust the attribute of the video frame in the video stream comprises instructions to:
determine a performance score for the performance of the client; and
determine to adjust the attribute of the video frame in the video stream in response to the performance score being greater than a threshold score.

15. The electronic device of claim 12, wherein the at least one program causing the at least one processor to determine whether to adjust the attribute of the video frame in the video stream comprises instructions to:
determine a group of device types of a group of devices having a performance available for adjusting an attribute of a video frame in the video stream; and
determine that the client has the performance for adjusting the attribute of the video frame in the video stream in response to a type of the client belonging to the group of device types.

16. The electronic device of claim 12, wherein the attribute comprises sharpness, the color value is a color value of the pixel in a first color space, and the at least one program causing the at least one processor to adjust the color value of the pixel in the video frame comprises instructions to:
obtain the color value of the pixel and a group of color values of a group of pixels located around the pixel in the first color space;
determine, based on the color value and the group of color values, a grayscale value of a luminance component for the pixel and a group of grayscale values of luminance components for the group of pixels in a second color space;
adjust the grayscale value of the luminance component based on the grayscale value and the group of grayscale values; and
update the color value of the pixel in the video frame based on the adjusted luminance component to adjust the sharpness of the video frame.

17. The electronic device of claim 16, wherein the at least one program causing the at least one processor to adjust the grayscale value of the luminance component comprises instructions to:
determine a group of gradients corresponding to the pixel based on the grayscale value and the group of grayscale values;
determine a sharpness parameter for adjusting the video frame; and
adjust the grayscale value of the luminance component based on a maximum gradient in the group of gradients and the sharpness parameter.

18. The electronic device of claim 16, wherein the at least one program causing the at least one processor to update the color value of the pixel in the video frame to adjust the sharpness of the video frame comprises instructions to:
update the color value of the pixel by performing color space conversion on the adjusted luminance component.

19. The electronic device of claim 16, wherein the at least one program causing the at least one processor to adjust the color value of the pixel in the video frame further comprises instructions to:
obtain a texture length and a texture width of a texture for the video frame;
determine a pixel step size for the pixel based on the texture width and the texture length; and
determine the group of pixels based on the pixel step size and the pixel.

20. A non-transitory computer-readable storage medium having a computer program stored thereon, the computer program, when executed by a processor, causes the processor to:
determine, at a client, a video stream for live streaming;
determine, based on a performance of the client, whether to adjust an attribute of a video frame in the video stream;
adjust a color value of a pixel in the video frame in response to determining to adjust the attribute of the video frame; and
display the video frame in the video stream having the adjusted pixel.
